(19) United States
(12) Patent Application Publication
(10) Pub. No.: US 2026/0050150 A1
(43) Pub. Date: Feb. 19, 2026

(54) OPTICAL SYSTEM, IMAGE PICKUP APPARATUS, SYSTEM, AND MOVING APPARATUS

(71) Applicant: CANON KABUSHIKI KAISHA, Tokyo (JP)

(72) Inventor: Naoto DOUJOU, Tochigi (JP)

(21) Appl. No.: 19/265,367

(22) Filed: Jul. 10, 2025

(30) Foreign Application Priority Data
Aug. 16, 2024 (JP) 2024-137050

(51) Int. Cl. G02B 17/08; B60Q 9/00; B60T 7/22; B60W 30/09; G02B 27/28

(52) U.S. Cl. CPC G02B 17/0804; B60Q 9/008; B60T 7/22; B60W 30/09; G02B 27/28; B60T 2201/022; B60T 2210/32; B60W 2554/802

(57) ABSTRACT

Optical systems, image pickup apparatuses, systems, and moving apparatuses are provided herein. One or more optical systems include a first meniscus lens and a second meniscus lens spaced from each other and arranged in this order from an object side to an image side. The first meniscus lens includes a first transmissive reflective surface that is convex toward the object side. The second meniscus lens includes a second transmissive reflective surface that is convex toward the object side. Light from the object side transmits through the first transmissive reflective surface, is reflected toward the object side by the second transmissive reflective surface, is reflected toward the image side by the first transmissive reflective surface, and transmits through the second transmissive reflective surface toward the image side.

### BACKGROUND

### Field of the Technology

The present disclosure relates to one or more embodiments of an optical system, an image pickup apparatus, a system, and a moving apparatus.

### Description of the Related Art

Optical systems have recently been proposed that use a reflective surface to control an incident angle of a light ray onto an image sensor. Japanese Patent Application Laid-Open No. 2009-80411 discloses a configuration that uses a transmissive reflective surface.

### SUMMARY

One or more embodiments of an optical system according to one or more aspects of the present disclosure may include a first meniscus lens and a second meniscus lens spaced from each other and arranged in this order from an object side to an image side. The first meniscus lens may include a first transmissive reflective surface that is convex toward the object side. The second meniscus lens may include a second transmissive reflective surface that is convex toward the object side. Light from the object side may transmit through the first transmissive reflective surface, may be reflected toward the object side by the second transmissive reflective surface, may be reflected toward the image side by the first transmissive reflective surface, and may transmit through the second transmissive reflective surface toward the image side. One or more image pickup apparatuses, systems, and moving apparatuses may include the above one or more optical systems in accordance with one or more other aspects of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an optical path in an optical system according to this embodiment.

FIG. 2 is a sectional view of an optical system according to Example 1.

FIG. 3 is an MTF diagram of the optical system according to Example 1.

FIG. 4 is a sectional view of an optical system according to Example 2.

FIG. 5 is an MTF diagram of the optical system according to Example 2.

FIG. 6 is a sectional view of an optical system according to Example 3.

FIG. 7 is an MTF diagram of the optical system according to Example 3.

FIG. 8 is a sectional view of an optical system according to Example 4.

FIG. 9 is an MTF diagram of the optical system according to Example 4.

FIG. 10 is a schematic diagram of principal parts of an image pickup apparatus according to this embodiment.

FIG. 11 is a functional block diagram of an on-board (in-vehicle) system according to this embodiment.

FIG. 12 is a schematic diagram of principal parts of a vehicle according to this embodiment.

FIG. 13 is a flowchart illustrating an example of the operation of the on-board system according to this embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of examples according to the present disclosure. Corresponding elements in respective figures will be designated by the same reference numerals, and a duplicate description thereof will be omitted.

The optical system according to each example can be used in an image pickup apparatus such as a smartphone imaging camera, a distance detecting camera, a fixed lens camera, a disposable film camera, or an on-board camera, which has an image sensor that photoelectrically converts an image formed by the optical system. The optical system according to each example can also be used in an interchangeable lens of a video camera, a digital still camera, or an interchangeable lens camera.

The optical system according to each example includes a first transmissive reflective surface and a second transmissive reflective surface arranged in this order from the object side to the image side. In addition, a linear polarizer, and an element (phase shifter) for giving a phase difference (retardation) to incident light may be arranged in this order from the object side to the image side on the object side of the first transmissive reflective surface. The phase shifter may be disposed between the first transmissive reflective surface and the second transmissive reflective surface. Light from the object side transmits through the first transmissive reflective surface, is reflected by the second transmissive reflective surface toward the object side, is reflected by the first transmissive reflective surface toward the image side, and transmits through the second transmissive reflective surface toward the image surface. The phase shifter can use, for example, a waveplate (phase plate) such as a quarter waveplate (QWP) or a 45° optical rotator (Faraday rotator, etc.). Each example uses a QWP as the phase shifter.

The first and second transmissive reflective surfaces may not have a transmittance of 50% and a reflectance of 50%. A ratio of the transmittance and reflectance for randomly polarized light may be in the range of 1:3 to 3:1. Randomly polarized light is light with Stokes parameters S0=1, S1=S2=S3=0. The first and second transmissive reflective surfaces may absorb light.

The QWP can use, for example, a polymer film or liquid crystal alignment layer having birefringence. A laminate of such polymer films or liquid crystal alignment layers can be used as the QWP. Properly stacking them can provide a phase difference close to a quarter of the wavelength in a wide wavelength range. In addition to the above, an inorganic waveplate from Dexerials Corporation can be used as the QWP.

The QWP can be disposed, for example, by bonding with the first or second transmissive reflective surface. The QWP can also be disposed as a separate member from these transmissive reflective surfaces. For example, the film may be inserted directly into the optical path, or a film bonded to a glass plate may be inserted into the optical path. A lens may be formed or bonded on one or both sides of the QWP. For example, a lens may be molded on one or both sides of an inorganic waveplate using wafer-level optics technology using an inorganic waveplate as a substrate.

Next follows a description of a characteristic configuration of the optical system according to each example.

The optical system according to each example includes first and second meniscus lenses spaced each other and arranged in this order from the object side to the image side. The first meniscus lens includes a first transmissive reflective surface that is convex toward the object side. The second meniscus lens includes a second transmissive reflective surface that is convex toward the object side. An off-axis ray traveling from the object side to the image side transmits through the first transmissive reflective surface, is reflected by the second transmissive reflective surface, is reflected by the first transmissive reflective surface, and transmits through the second transmissive reflective surface to become a light ray with relatively good telecentricity. The first and second transmissive reflective surfaces have a convex shape toward the object side, so that the off-axis ray traveling from the object side to the image side moves in a direction orthogonal to the optical axis between the transmission point of the first transmissive reflective surface and the transmission point of the second transmissive reflective surface. Therefore, the transmission point of the second transmissive reflective surface and the imaging position can be located at approximately the same position in the direction orthogonal to the optical axis. In other words, the light ray can be telecentric. A meniscus lens is a lens in which one lens surface is convex and the other lens surface is concave. No lens may be disposed between the first meniscus lens and the second meniscus lens. Each of the first and second meniscus lenses may include the first and second transmissive reflective surface on the image side.

The light ray transmits through the first transmissive reflective surface, is reflected by the second transmissive reflective surface, and returns to the first transmissive reflective surface, but the optical path between them goes back and forth, and the light ray bending effect can be provided. The length of the light ray that is originally required is folded, and the overall length of the lens can be reduced.

Since the first and second transmissive reflective surfaces have a reflective structure, no chromatic aberration occurs, and positive and negative Petzval sums can be manipulated with a large refractive power, so good imaging performance can be obtained with a small number of lenses and a large aperture diameter.

Next follows a description of the configuration that may be satisfied in the optical system according to each example.

One of the first and second transmissive reflective surfaces may be a surface that separates incident light into reflected light and transmitting light according to the polarization state. More specifically, as described later, a polarization selective transmissive reflective element may be used as one of the first and second transmissive reflective surfaces. Examples of the polarization selective transmissive reflective surface include “WGF” manufactured by Asahi Kasei Corporation and “IQPE” manufactured by 3M Company. An optical element may be used as the polarization selective transmissive reflective surface, which is created by forming a grid on the lens reflecting surface during lens molding and then depositing, printing, or lithographically depositing a metal or dielectric on the grid. Alternatively, a half-mirror, cholesteric liquid crystal, holographic optical element, etc., may be used. In a case where a half-mirror is used, a light amount of randomly polarized light incident from the object side is 12.5% or less by the time it reaches the image plane. By using a cholesteric liquid crystal or a holographic optical element, a light amount on the image plane can be approximately doubled compared to when a half-mirror is used.

In order for the first transmissive reflective surface to converge a large light beam, a positive refractive power is required. In order to correct the spherical aberration and curvature of field that occur due to the positive refractive power, the second transmissive reflective surface must have a negative refractive power. In this way, the positive and negative refractive powers of the reflective surfaces can correct spherical aberration and curvature of field, while the first and second transmissive reflective surfaces can correct field curvature.

The optical system according to each example may be rotationally symmetrical about the optical axis.

In the optical system according to each example, the refractive power of the first meniscus lens provided with the first transmissive reflective surface and the second meniscus lens provided with the second transmissive reflective surface may be smaller than the refractive power of the optical system. In a case where the refractive power of each meniscus lens is large, unnecessary aberrations such as chromatic aberration will occur in each lens unit. Since the aspheric lens effect may be large during the round trip of the optical path, the refractive power of each meniscus lens during transmission may be as small as possible.

Next follows a description of conditions that may be satisfied by the optical system of each example. The optical system according to each example may satisfy one or more of the following inequalities (1) to (5):

$$0. < \vert f / f 1 \vert \leq 0.47 \qquad ( 1 )$$

$$0. < \vert f / f 2 \vert \leq 0. 56 \qquad ( 2 )$$

$$1.11 \leq \vert R 1 / f \vert \leq 3.47 \qquad ( 3 )$$

$$1. \leq \vert R 2 / f \vert \leq 3.46 \qquad ( 4 )$$

$$0.29 L 1 / f \leq 1.13 \qquad ( 5 )$$

Here, f is a focal length of the optical system. f1 is a focal length of the first meniscus lens. f2 is a focal length of the second meniscus lens. R1 is a radius of curvature of the first transmissive reflective surface. R2 is a radius of curvature of the second transmissive reflective surface. L1 is a distance on the optical axis between the first and second meniscus lenses (a distance on the optical axis (air distance) from a lens surface of the first meniscus lens disposed on the image side of the first meniscus lens to a lens surface of the second meniscus lens disposed on the object side of the second meniscus lens).

In a case where the value becomes higher than the upper limit of inequality (1), the refractive power of the first meniscus lens increases, and a longitudinal chromatic aberration amount increases.

In a case where the value becomes higher than the upper limit of inequality (2), the refractive power of the second meniscus lens increases, and a lateral chromatic aberration amount increases.

In a case where the value becomes lower than the lower limit of inequality (3), the positive refractive power of the first meniscus lens increases, and spherical aberration increases on the under-correction side and cannot be fully corrected. In a case where the value becomes higher than the upper limit of inequality (3), the positive refractive power of the first meniscus lens reduces, and spherical aberration increases on the overcorrection side.

In a case where the value becomes lower than the lower limit of inequality (4), the negative refractive power of the second meniscus lens increases, and large negative spherical aberration cannot be fully corrected. In a case where the value becomes higher than the upper limit of inequality (4), the negative refractive power of the second meniscus lens reduces, and it becomes insufficient to correct spherical aberration and curvature of field.

In a case where the value becomes lower than the lower limit of inequality (5), a distance on the optical axis between the first and second transmissive reflective surfaces is reduced, a light beam may be moved in a direction orthogonal to the optical axis within the narrow distance, and it becomes difficult to secure telecentricity when transmitting through the second transmissive reflective surface. In order to secure telecentricity, it is necessary to strengthen the shape of the convex surface facing the object side, an unnecessary air gap is generated between the second transmissive reflective surface and the imaging point, and the size increases. In a case where the value becomes higher than the upper limit of inequality (5), the distance on the optical axis between the first and second transmissive reflective surfaces increases, and it becomes difficult to place lenses capable of correcting aberrations and thus difficult to correct aberrations.

Inequalities (1) to (5) may be replaced with inequalities (1a) to (5a) below:

$$0. < \vert f / f 1 \vert \leq 0.44 \qquad ( 1 a )$$

$$0. < \vert f / f 2 \vert \leq 0.52 \qquad ( 2 a )$$

$$1.29 \leq \vert R 1 / f \vert \leq 3.22 \qquad ( 3 a )$$

$$1.16 \leq \vert R 2 / f \vert \leq 3.21 \qquad ( 4 a )$$

$$0.34 \leq L 1 / f \leq 1.05 \qquad ( 5 a )$$

Inequalities (1) to (5) may be replaced with inequalities (1b) to (5b) below:

$$0. < \vert f / f 1 \vert \leq 0.4 \qquad ( 1 b )$$

$$0. < \vert f / f 2 \vert \leq 0.48 \qquad ( 2 b )$$

$$1.47 \leq \vert R 1 / f \vert \leq 2.97 \qquad ( 3 b )$$

$$1.33 \leq \vert R 2 / f \vert \leq 2.97 \qquad ( 4 b )$$

$$0.39 \leq L 1 / f \leq 0.97 \qquad ( 5 b )$$

Table 1 summarizes various values in each example.

TABLE 1

| | FOCAL | HORIZONTAL | | | | | | | | | | |
|---|---|---|---|---|---|---|---|---|---|---|---|---|
| | LENGTH f | ANGLE OF VIEW | f1 | f2 | R1 | R2 | L1 | \| f/f1\| | \|f/f2\| | \|R1/f\| | \|R2/f\| | L1/f |
| EXAMPLE 1 | 18.5 | 30 | −460.4 | −4167.3 | 34.1 | 31.1 | 9.0 | 0.040 | 0.004 | 1.842 | 1.681 | 0.484 |
| EXAMPLE 2 | 14.2 | 40 | −42.4 | 1682.3 | 27.8 | 23.5 | 9.2 | 0.335 | 0.008 | 1.960 | 1.659 | 0.649 |
| EXAMPLE 3 | 11.4 | 50 | −22214.1 | −1456.7 | 28.2 | 22.0 | 9.2 | 0.001 | 0.008 | 2.478 | 1.931 | 0.807 |
| EXAMPLE 4 | 18.4 | 30 | 348.8 | 45.9 | 35.7 | 45.4 | 10.4 | 0.053 | 0.400 | 1.941 | 2.472 | 0.569 |

### Configuration Utilizing Polarization

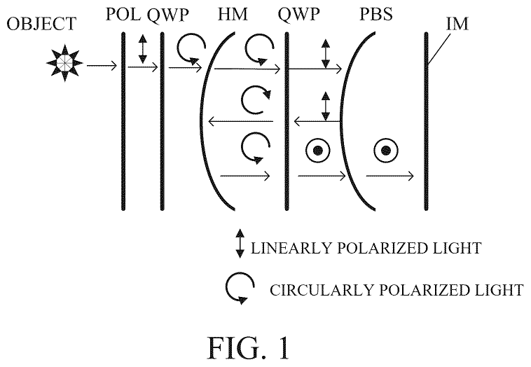

Referring now to FIG. 1, a description will be given of the configuration utilizing polarization. The optical system according to each example includes, in order from the object side to the image side, a linear polarizer POL, a quarter waveplate QWP, a first transmissive reflective surface HM, a quarter waveplate QWP, and a second transmissive reflective surface PBS.

Light from the object side becomes linearly polarized light after transmitting through the linear polarizer POL, and becomes circularly polarized light after transmitting through the quarter waveplate QWP. The circularly polarized light becomes linearly polarized light after transmitting through the first transmissive reflective surface HM and the quarter waveplate QWP, and is reflected as linearly polarized light due to the polarized reflection action of the second transmissive reflective surface PBS. The light beam that is converted to circularly polarized light after transmitting through the quarter waveplate QWP and reflected by the first transmissive reflective surface HM is converted to linearly polarized light with an orthogonal polarization direction after transmitting through the quarter waveplate QWP, and then transmits through the second transmissive reflective surface PBS and is guided to the image sensor IM.

The optical system according to each example will be described below.

### Example 1

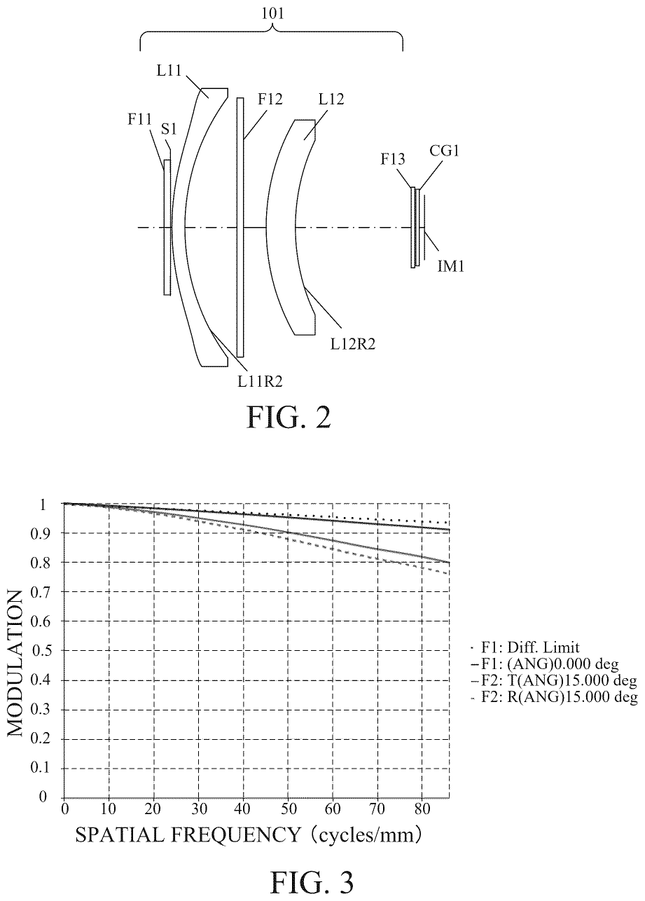

FIG. 2 is a sectional view of an optical system 101 according to Example 1. The optical system 101 includes, in order from the object side to the image side, a polarizing element F11, an open diaphragm S1, a first meniscus lens L11, an element F12, and a second meniscus lens L12. The polarizing element F11 serves both as a linear polarizer POL and a quarter waveplate QWP. The linear polarizer POL and the quarter waveplate QWP may be arranged as separate elements for each function. The first meniscus lens L11 includes a first transmissive reflective surface L11R2. The element F12 has a function of a quarter waveplate QWP. The second meniscus lens L12 includes a second transmissive reflective surface L12R2. An element F13 having functions, such as a wavelength selective filter and a polarizing element, and a cover glass CG1 are disposed on the object side of the image sensor IM1. Tables 2 and 3 summarize numerical data of this example.

TABLE 2

| | | RADIUS OF | | |
|---|---|---|---|---|
| | | CURVATURE | DISTANCE | GLASS MATERIAL |
| | | — | INFINITY | |
| F11 | SPHERICAL SURFACE | FLAT | 1.00 | POLARIZING ELEMENT MATERIAL |
| | SPHERICAL SURFACE | FLAT | 0 | |
| S1 | SPHERICAL SURFACE | FLAT | 0.20 | |
| L11 | ASPHERIC SURFACE11 | 38.389 | 2.00 | MTAFD305_HOYA |
| | ASPHERIC SURFACE12 | 34.126 | 8.00 | |
| F12 | SPHERICAL SURFACE | FLAT | 1.00 | POLARIZING ELEMENT MATERIAL |
| | SPHERICAL SURFACE | FLAT | 3.49 | |
| L12 | ASPHERIC SURFACE13 | 33.50 | 4.48 | MTAFD305_HOYA |
| | SPHERICAL SURFACE | 31.15 | 17.79 | |
| F13 | SPHERICAL SURFACE | FLAT | 0.58 | FILTER OR POLARIZING |
| | | | | ELEMENT MATERIAL |
| | SPHERICAL SURFACE | FLAT | 0.15 | |
| CG1 | SPHERICAL SURFACE | FLAT | 0.50 | NBK7_SCHOTT |
| | SPHERICAL SURFACE | FLAT | 0.81 | |
| IMAGE | | — | | |

Table 3 illustrates aspheric shape data. The aspheric shape is expressed by the following equation:

$$Z = \frac{( 1 / R ) {h}^{2}}{1 + \sqrt{1 - ( 1 + k ) {( 1 / R )}^{2} {h}^{2}}} + {Ah}^{4} + {Bh}^{6} + {Ch}^{8} + {Dh}^{10} + {Eh}^{12} + {Fh}^{14}$$

where Z is a displacement amount from a surface vertex in the optical axis direction, h is a height from the optical axis in the direction orthogonal to the optical axis, R is a paraxial radius of curvature, k is a conic constant, and Ai (i=2, 4, 6, 8 . . . ) are aspheric coefficients of each order.

TABLE 3

| | ASPHERIC | ASPHERIC | ASPHERIC |
|---|---|---|---|
| | SURFACE 11 | SURFACE 12 | SURFACE 13 |
| PARAXIAL RADIUS OF CURVATURE R | 38.389 | 34.126 | 33.501 |
| CONIC COEFFICIENT k | −1.000 | −1.000 | 1.192 |
| 4^{TH} ORDER COEFFICIENT A | −3.651E−06 | 3.621E−06 | −4.067E−06 |
| 6^{TH} ORDER COEFFICIENT B | −1.162E−08 | 1.699E−09 | −2.205E−09 |
| 8^{TH} ORDER COEFFICIENT C | 4.307E−11 | 7.486E−13 | −1.214E−11 |
| 10^{TH} ORDER COEFFICIENT D | −3.504E−13 | 1.673E−15 | −8.920E−15 |
| 12^{TH} ORDER COEFFICIENT E | 6.180E−16 | 0.000E+00 | −1.634E−17 |
| 14^{TH} ORDER COEFFICIENT E | 0.000E+00 | 0.000E+00 | 0.000E+00 |

FIG. 3 illustrates an MTF diagram of the optical system 101. A sufficiently high MTF value is obtained at 83 lp/mm, which is half the Nyquist frequency of the 3.0 μm pitch sensor.

### Example 2

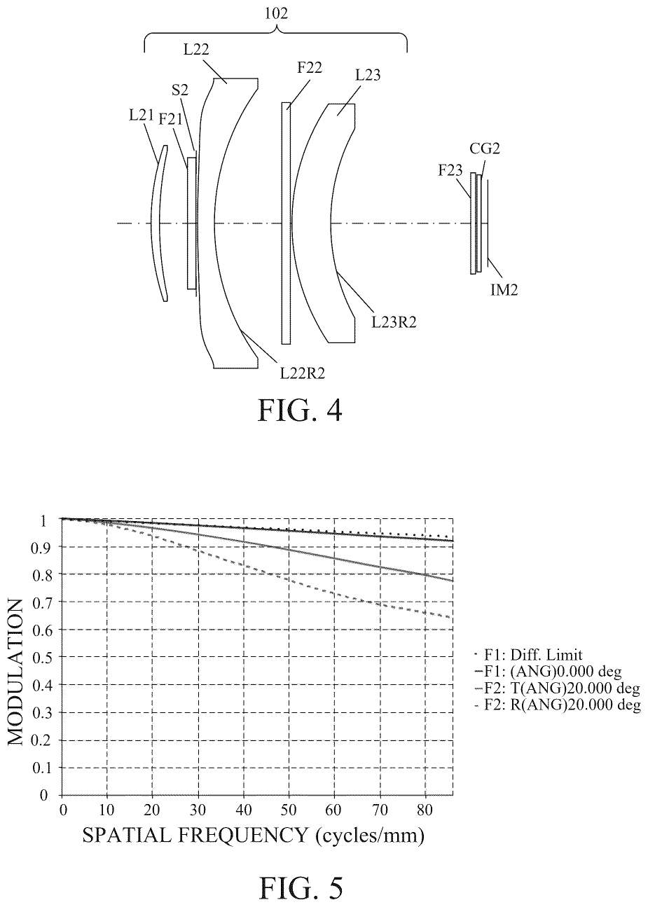

FIG. 4 is a sectional view of an optical system 102 according to Example 2. The optical system 102 includes, in order from the object side to the image side, a positive lens L21, a polarizing element F21, an open diaphragm S2, a first meniscus lens L22, an element F22, and a second meniscus lens L23. The polarizing element F21 serves both as a linear polarizer POL and a quarter waveplate QWP. The first meniscus lens L22 includes a first transmissive reflective surface L22R2. The element F22 has a function of a quarter waveplate QWP. The second meniscus lens L23 includes a second transmissive reflective surface L23R2. An element F23 having functions, such as a wavelength selective filter and a polarizing element, and a cover glass CG2 are disposed on the object side of the image sensor IM2. Tables 4 and 5 summarize numerical data of this example.

TABLE 4

| | | RADIUS OF | | |
|---|---|---|---|---|
| | | CURVATURE | DISTANCE | GLASS MATERIAL |
| | | — | INFINITY | |
| L21 | SPHERICAL SURFACE | 28.933 | 1.00 | STIH14_OHARA |
| | SPHERICAL SURFACE | 40.671 | 3.33 | |
| F21 | SPHERICAL SURFACE | FLAT | 0.00 | POLARIZING ELEMENT MATERIAL |
| | SPHERICAL SURFACE | FLAT | 1.00 | |
| S2 | SPHERICAL SURFACE | FLAT | 0.20 | |
| L22 | ASPHERIC SURFACE 21 | 125.587 | 2.00 | MTAFD305_HOYA |
| | ASPHERIC SURFACE 22 | 27.811 | 8.00 | |
| F22 | SPHERICAL SURFACE | FLAT | 1.00 | POLARIZING ELEMENT MATERIAL |
| | SPHERICAL SURFACE | FLAT | 0.20 | |
| L23 | ASPHERIC SURFACE 23 | 25.267 | 4.60 | MTAFD305_HOYA |
| | SPHERICAL SURFACE | 23.528 | 16.64 | |
| F23 | SPHERICAL SURFACE | FLAT | 0.58 | FILTER OR POLARIZING |
| | | | | ELEMENT MATERIAL |
| | SPHERICAL SURFACE | FLAT | 0.15 | |
| CG2 | SPHERICAL SURFACE | FLAT | 0.50 | NBK7_SCHOTT |
| | SPHERICAL SURFACE | FLAT | 0.81 | |
| IMAGE | | — | | |

TABLE 5

| | ASPHERIC | ASPHERIC | ASPHERIC |
|---|---|---|---|
| | SURFACE 21 | SURFACE 22 | SURFACE 23 |
| PARAXIAL RADIUS OF CURVATURE R | 125.587 | 27.811 | 25.267 |
| CONIC COEFFICIENT k | −1.000 | −1.000 | −0.532 |
| 4^{TH} ORDER COEFFICIENT A | −1.562E−05 | 6.466E−06 | 4.563E−06 |
| 6^{TH} ORDER COEFFICIENT B | 4.903E−08 | 6.343E−09 | −7.958E−09 |
| 8^{TH} ORDER COEFFICIENT C | −1.498E−09 | −1.445E−12 | 1.130E−10 |
| 10^{TH} ORDER COEFFICIENT D | 1.398E−11 | 1.869E−14 | −4.713E−13 |
| 12^{TH} ORDER COEFFICIENT E | −2.893E−14 | 0.000E+00 | 8.174E−16 |
| 14^{TH} ORDER COEFFICIENT F | 0.000E+00 | 0.000E+00 | 0.000E+00 |

FIG. 5 is an MTF diagram of the optical system 102. A sufficiently high MTF value is obtained at 83 lp/mm, which is half the Nyquist frequency of the 3.0 μm pitch sensor.

### Example 3

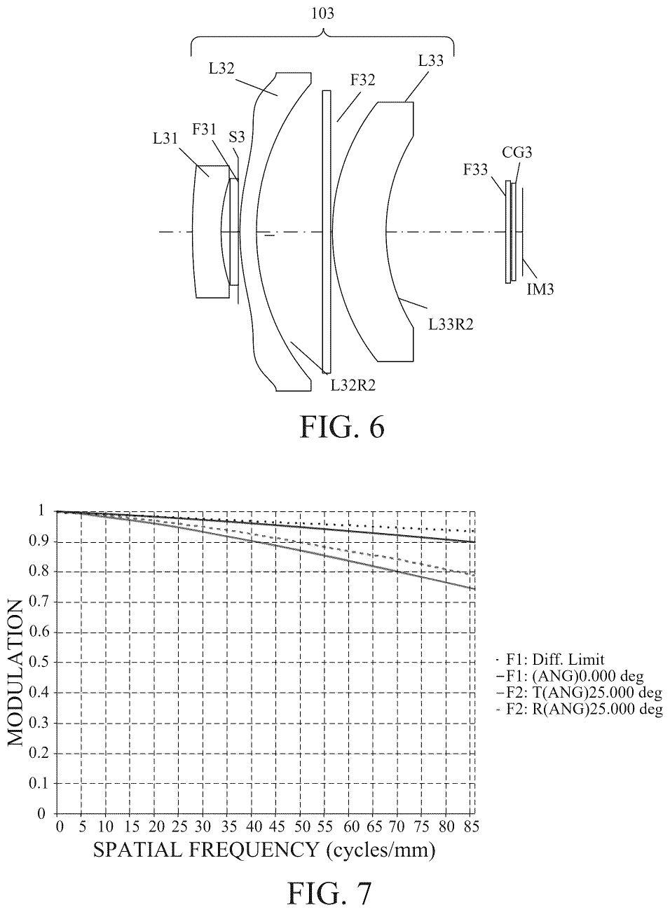

FIG. 6 is a sectional view of an optical system 103 according to Example 3. The optical system 103 includes, in order from the object side to the image side, a negative lens L31, a polarizing element F31, an open diaphragm S3, a first meniscus lens L32, an element F32, and a second meniscus lens L33. The polarizing element F31 serves both as a linear polarizer POL and a quarter waveplate QWP. The first meniscus lens L32 includes a first transmissive reflective surface L32R2. The element F32 has a function of a quarter waveplate QWP. The second meniscus lens L33 includes a second transmissive reflective surface L33R2. An element F33 having functions, such as a wavelength selective filter and a polarizing element, and a cover glass CG3 are disposed on the object side of the image sensor IM3. Tables 6 and 7 summarize numerical data of this example.

TABLE 6

| | | RADIUS OF | | |
|---|---|---|---|---|
| | | CURVATURE | DISTANCE | GLASS MATERIAL |
| | | — | INFINITY | |
| L31 | SPHERICAL SURFACE | 66.802 | 3.47 | POLARIZING ELEMENT MATERIAL |
| | SPHERICAL SURFACE | 20.414 | 1.09 | |
| F31 | SPHERICAL SURFACE | FLAT | 1.00 | STIH13_OHARA |
| | SPHERICAL SURFACE | FLAT | 0.00 | |
| S3 | SPHERICAL SURFACE | FLAT | 0.20 | |
| L32 | ASPHERIC SURFACE 31 | 28.992 | 2.00 | LBSL7_OHARA |
| | ASPHERIC SURFACE 32 | 28.239 | 8.00 | |
| F32 | SPHERICAL SURFACE | FLAT | 1.00 | POLARIZING ELEMENT MATERIAL |
| | SPHERICAL SURFACE | FLAT | 0.20 | |
| L33 | ASPHERIC SURFACE 33 | 25.270 | 6.50 | NBFD32_HOYA |
| | SPHERICAL SURFACE | 22.004 | 14.49 | |
| F33 | SPHERICAL SURFACE | FLAT | 0.58 | FILTER OR POLARIZING |
| | | | | ELEMENT MATERIAL |
| | SPHERICAL SURFACE | FLAT | 0.15 | |
| CG3 | SPHERICAL SURFACE | FLAT | 0.5 | NBK7_SCHOTT |
| | SPHERICAL SURFACE | FLAT | 0.81 | |
| IMAGE | | — | | |

TABLE 7

| | ASPHERIC | ASPHERIC | ASPHERIC |
|---|---|---|---|
| | SURFACE 31 | SURFACE 32 | SURFACE 33 |
| PARAXIAL RADIUS OF CURVATURE R | 28.992 | 28.239 | 25.270 |
| CONIC COEFFICIENT k | −1.000 | −1.000 | −0.589 |
| 4^{TH} ORDER COEFFICIENT A | −2.766E−05 | 6.232E−06 | 4.489E−06 |
| 6^{TH} ORDER COEFFICIENT B | 1.343E−07 | 5.279E−09 | −2.059E−09 |
| 8^{TH} ORDER COEFFICIENT C | −4.239E−09 | −6.703E−14 | 8.761E−11 |
| 10^{TH} ORDER COEFFICIENT D | 2.144E−11 | 1.296E−14 | −3.540E−13 |
| 12^{TH} ORDER COEFFICIENT E | −2.893E−14 | 0.000E+00 | 6.640E−16 |
| 14^{TH} ORDER COEFFICIENT F | 0.000E+00 | 0.000E+00 | 0.000E+00 |

FIG. 7 is an MTF diagram of the optical system 103. A sufficiently high MTF value is obtained at 83 lp/mm, which is half the Nyquist frequency of the 3.0 μm pitch sensor.

### Example 4

FIG. 8 is a sectional view of an optical system 104 according to Example 4. The optical system 104 includes, in order from the object side to the image side, a polarizing element F41, an open diaphragm S4, a first meniscus lens L41, an element F42, a second meniscus lens L42, and a positive lens L43. The polarizing element F41 serves both as a linear polarizer POL and a quarter waveplate QWP. The first meniscus lens L41 includes a first transmissive reflective surface L41R2. The element F42 has a function of a quarter waveplate QWP. The second meniscus lens L42 includes a second transmissive reflective surface L42R2. An element F43 having functions, such as a wavelength selective filter and a polarizing element, and a cover glass CG4 are disposed on the object side of the image sensor IM4. Tables 8 and 9 summarize numerical data of this example.

TABLE 8

| | | RADIUS OF | | |
|---|---|---|---|---|
| | | CURVATURE | DISTANCE | GLASS MATERIAL |
| | | — | INFINITY | |
| F41 | SPHERICAL SURFACE | FLAT | 1.00 | POLARIZING ELEMENT MATERIAL |
| | SPHERICAL SURFACE | FLAT | 0.00 | |
| S4 | SPHERICAL SURFACE | FLAT | 0.20 | |
| L41 | ASPHERIC SURFACE 41 | 32.651 | 2.00 | MTAFD305_HOYA |
| | ASPHERIC SURFACE 42 | 35.652 | 8.00 | |
| F42 | SPHERICAL SURFACE | FLAT | 1.00 | POLARIZING ELEMENT MATERIAL |
| | SPHERICAL SURFACE | FLAT | 1.45 | |
| L42 | ASPHERIC SURFACE 43 | 51.24 | 6.50 | MTAFD305_HOYA |
| | SPHERICAL SURFACE | 45.40 | 6.09 | |
| L43 | SPHERICAL SURFACE | 38.56 | 6.09 | SFSL5_OHARA |
| | SPHERICAL SURFACE | −50.28 | 6.50 | |
| F43 | SPHERICAL SURFACE | FLAT | 0.58 | FILTER OR POLARIZING |
| | | | | ELEMENT MATERIAL |
| | SPHERICAL SURFACE | FLAT | 0.15 | |
| CG4 | SPHERICAL SURFACE | FLAT | 0.50 | NBK7_SCHOTT |
| | SPHERICAL SURFACE | FLAT | 0.81 | |
| IMAGE | | — | | |

TABLE 9

| | ASPHERIC | ASPHERIC | ASPHERIC |
|---|---|---|---|
| | SURFACE 11 | SURFACE 12 | SURFACE 13 |
| PARAXIAL RADIUS OF CURVATURE R | 32.651 | 35.652 | 51.235 |
| CONIC COEFFICIENT k | −1.000 | −1.000 | 1.179 |
| 4^{TH} ORDER COEFFICIENT A | 2.594E−06 | 3.444E−06 | −3.240E−06 |
| 6^{TH} ORDER COEFFICIENT B | −8.502E−09 | 1.908E−09 | 4.720E−10 |
| 8^{TH} ORDER COEFFICIENT C | 7.221E−11 | −1.570E−12 | 3.825E−12 |
| 10^{TH} ORDER COEFFICIENT D | −2.946E−13 | 6.171E−15 | −9.085E−14 |
| 12^{TH} ORDER COEFFICIENT E | 5.053E−16 | 0.000E+00 | 1.151E−16 |
| 14^{TH} ORDER COEFFICIENT F | 0.000E+00 | 0.000E+00 | 0.000E+00 |

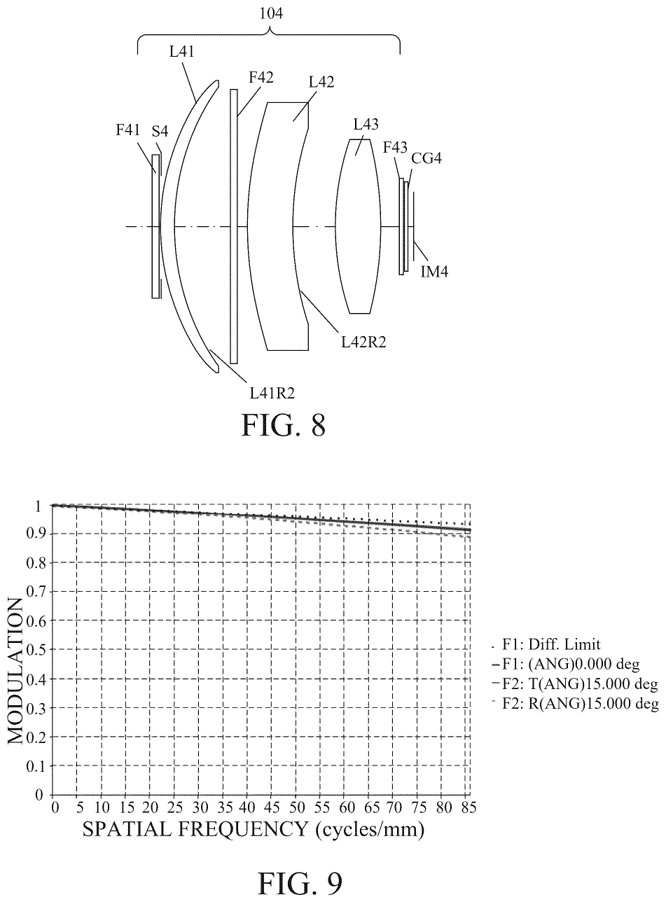

FIG. 9 is an MTF diagram of the optical system 103. A sufficiently high MTF value is obtained at 83 lp/mm, which is half the Nyquist frequency of the 3.0 μm pitch sensor.

### Image Pickup Apparatus

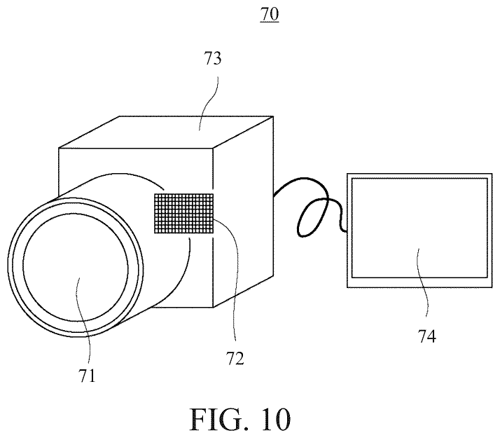

An image pickup apparatus 70 using any one of the optical systems according to the above examples as an imaging optical system. FIG. 10 is a schematic diagram of principal parts of the image pickup apparatus 70. The image pickup apparatus 70 includes an imaging optical system 71, which is one of the optical systems according to the above examples, a light receiving element 72 that photoelectrically converts an image of an object formed by the imaging optical system 71, and a camera body (housing) 73 that holds the light receiving element 72. The imaging optical system 71 is held by a lens barrel (holding member) and connected to the camera body 73. A display unit 74 that displays an image acquired by the light receiving element 72 may be connected to the camera body 73. An image sensor (photoelectric conversion element) such as a CCD sensor or a CMOS sensor can be used as the light receiving element 72.

In a case where the image pickup apparatus 70 is used as a focus detecting apparatus, for example, an image sensor (imaging-surface phase-difference sensor) having pixels that can divide a light beam from an object into two and photoelectrically convert them can be used as the light receiving element 72. In a case where an object is on the front focal plane of the imaging optical system 71, no positional shift occurs in the images corresponding to the two split light beams on the image plane of the imaging optical system 71. However, in a case where the object is located at a position other than the front focal plane of the imaging optical system 71, a positional shift occurs in each image. At this time, the positional shift of each image corresponds to a displacement amount from the front focal plane of the object, so a distance to the object can be measured by acquiring the positional shift amount and positional shift direction of each image using an imaging-surface phase-difference sensor.

The imaging optical system 71 and the camera body 73 may be attachable to and detachable from each other. That is, the imaging optical system 71 and the lens barrel may be configured as an interchangeable lens (lens apparatus). The optical system according to each example can be applied to a variety of optical apparatuses such as telescopes, binoculars, projectors (projection apparatuses), digital copiers, etc., as well as image pickup apparatuses such as digital still cameras, film-based cameras, video cameras, on-board cameras, and surveillance cameras.

### On-Board System

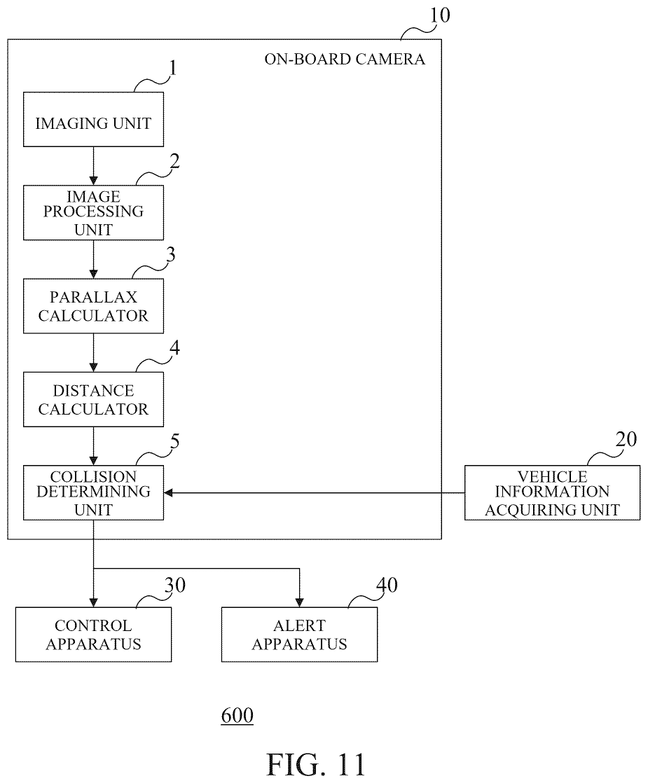

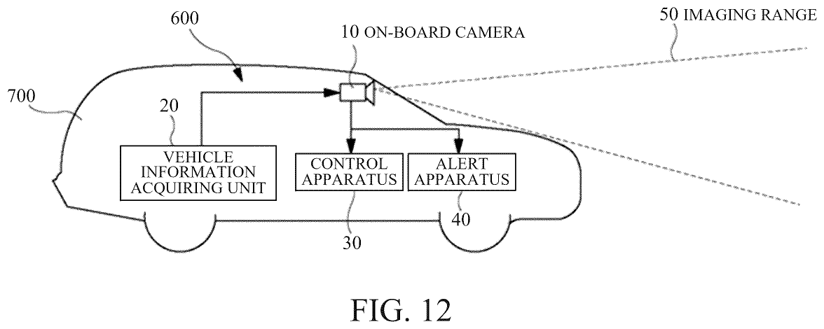

FIG. 11 is a configuration diagram of an on-board (in-vehicle) camera 10 according to this embodiment and an on-board system (driving support device) 600 having the same. The on-board system 600 is a system that is held by a movable body (moving apparatus) such as an automobile (vehicle, moving apparatus) and supports the driving (operation) of the vehicle based on image information on the surroundings of the vehicle acquired by the on-board camera 10. FIG. 12 is a schematic diagram of a vehicle 700 as a moving apparatus having the on-board system 600. In FIG. 12, an imaging range 50 of the on-board camera 10 is set in front of the vehicle 700, but the imaging range 50 may be set to the rear or side of the vehicle 700.

As illustrated in FIG. 11, the on-board system 600 includes the on-board camera 10, a vehicle information acquiring apparatus 20, a control apparatus (control unit, Electronic Control Unit: ECU) 30, and an alert apparatus (alert unit) 40. The on-board camera 10 further includes an imaging unit 1, an image processing unit 2, a parallax calculator 3, a distance acquiring unit (acquiring unit) 4, and a collision determining unit 5. The image processing unit 2, the parallax calculator 3, the distance acquiring unit 4, and the collision determining unit 5 constitute a processing unit (processor). The imaging unit 1 includes any one of the optical systems according to the above examples and an image sensor.

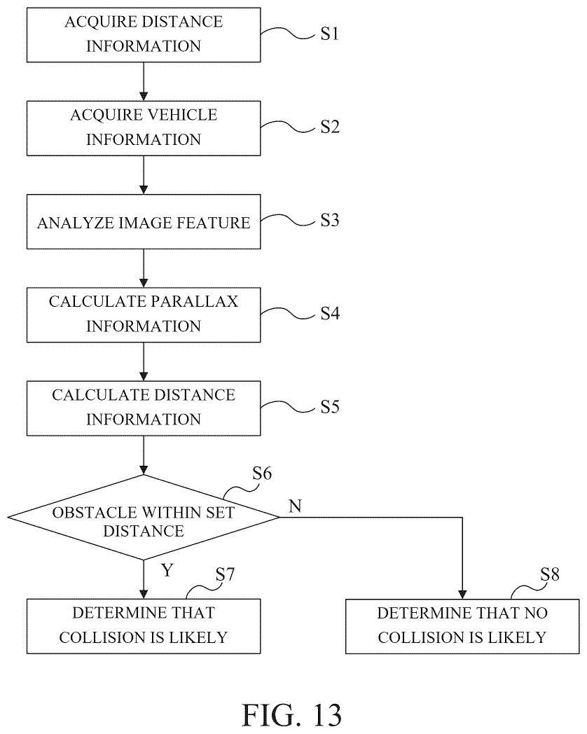

FIG. 13 is a flowchart illustrating an example operation of the on-board system 600 according to this embodiment. The operation of the on-board system 600 will be described below with reference to this flowchart.

First, in step S1, the imaging unit 1 images an object such as an obstacle and a pedestrian around the vehicle to acquire a plurality of image data (parallax image data).

In step S2, the vehicle information acquiring apparatus 20 acquires vehicle information. The vehicle information includes a vehicle speed, yaw rate, steering angle, and the like.

In step S3, the image processing unit 2 performs image processing for the plurality of image data acquired by the imaging unit 1. More specifically, the image processing unit 2 performs image feature analysis to analyze a feature amount such as an amount, direction, and a density value of an edge in the image data. Here, the image feature analysis may be performed for each of or a part of the plurality of image data.

In step S4, the parallax calculator 3 calculates parallax (image shift) information between the plurality of image data acquired by the imaging unit 1. Since known methods such as the SSDA method and area correlation method can be used as a method for calculating parallax information, a description thereof will be omitted in this embodiment. Steps S2, S3, and S4 may be performed in the above order, or may be performed in parallel.

In step S5, distance information about the object captured by the imaging unit 1 is acquired (calculated) by the distance acquiring unit 4. The distance information can be calculated based on the parallax information calculated by the parallax calculator 3 and the internal and external parameters of the imaging unit 1. The distance information here refers to information about the relative position of the object, such as the distance from the object, the defocus amount, and the image shift amount, and may directly represent the distance value of the object in the image, or may indirectly represent information corresponding to the distance value.

In step S6, the collision determining unit 5 uses the vehicle information acquired by the vehicle information acquiring apparatus 20 and the distance information calculated by the distance acquiring unit 4 to determine whether the distance to the object is within a preset distance range. Thereby, whether an object exists within a preset distance around the vehicle can be determined, and the likelihood of collision between the vehicle and the object can be determined. The collision determining unit 5 determines that the “collision is likely” in a case where an object is present within the set distance (step S7), and determines that “no collision is likely” in a case where there is no object within the set distance (step S8).

Next, in a case where the collision determining unit 5 determines that the “collision is likely,”, it notifies (transmits) the determination result to the control apparatus 30 and the alert apparatus 40. At this time, the control apparatus 30 controls the vehicle based on the determination result by the collision determining unit 5 (step S6), and the alert apparatus 40 alerts the user of the vehicle (driver, passenger) based on the determination result by the collision determining unit 5 (step S7). The notification of the determination result may be sent to at least one of the control apparatus 30 and the alert apparatus 40.

The control apparatus 30 can control the movement of the vehicle by outputting a control signal to a drive unit (engine, motor, etc.) of the vehicle. For example, it performs control such as applying the brake to the vehicle, releasing the accelerator, turning the steering wheel, and generating a control signal to generate a braking force on each wheel to suppress the output of the engine or motor. The alert apparatus 40 also alerts the user, for example, by issuing an alert sound (alarm), displaying alert information on the screen of a car navigation system or the like, or applying vibrations to a seat belt or steering wheel.

As described above, the on-board system 600 according to this embodiment can effectively detect an object, and avoid a collision between the vehicle and the object due to the above processing. In particular, applying any one of the optical systems according to the above examples to the on-board system 600 can detect an object and determine a collision over a wide angle of view while reducing the size of the entire on-board camera 10 and increasing the degree of freedom in arrangement.

The on-board camera 10 may have a single imaging unit 1 having an imaging-surface phase-difference sensor, or a stereo camera having two imaging units 1. In this case, even if an imaging-surface phase-difference sensor is not used, image data may be simultaneously acquired by each of the two synchronized imaging units 1, and the two image data may be used. However, in a case where a difference in imaging time between the two imaging units 1 is known, the two imaging units 1 do not need to be synchronized.

A variety of embodiments are conceivable for calculating the distance information. As an example, a pupil division type image sensor may have a plurality of pixel units regularly arranged in a two-dimensional array and be used as the image sensor for the imaging unit 1. In the pupil division type image sensor, one pixel unit includes a microlens and a plurality of photoelectric conversion units, and can receive a pair of light beams passing through different regions in the pupil of the optical system, and output paired image data from each photoelectric conversion unit.

An image shift amount for each region is calculated by a correlation calculation between the paired image data, and the distance acquiring unit 4 calculates image shift map data representing the distribution of the image shift amount. Alternatively, the distance acquiring unit 4 may further convert the image shift amount into a defocus amount to generate defocus map data representing the distribution of the defocus amount (distribution on a two-dimensional plane of the captured image). The distance acquiring unit 4 may also acquire distance map data of the distance to the object converted from the defocus amount.

The on-board system 600 and the vehicle 700 may also include a notification apparatus (notification unit) for notifying the manufacturer of the on-board system or the distributor of the moving apparatus, etc., of the collision of the vehicle 700 with an obstacle, in a case where the collision occurs. For example, the notification apparatus may be one that transmits information (collision information) on a collision between the vehicle 700 and an obstacle to a preset external notification destination by e-mail or the like.

Thus, the configuration in which the notification apparatus automatically notifies the collision information enable measures such as inspection and repair after the collision occurs to be promptly taken. The notification destination of the collision information may be an insurance company, a medical institution, the police, or any other party set by the user. The notification apparatus may be configured to notify the notification destination of not only the collision information but also failure information on each part and consumption information on consumables. The presence or absence of a collision may be detected using distance information acquired based on the output from the imaging unit 1, or may be performed by another detector (sensor).

In this embodiment, the on-board system 600 is applied to driving assistance (collision damage reduction), but is not limited to this example, and the on-board system 600 may be applied to cruise control (including an adaptive cruise control function) and automatic driving. The on-board system 600 is not limited to vehicles such as automobiles, but may be applied to movable units such as ships, aircraft, and industrial robots. The present disclosure is applicable not only to movable units but also to a variety of apparatuses that utilize object recognition, such as Intelligent Transport Systems (ITS).

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

In the configuration disclosed Japanese Patent Application Laid-Open No. 2009-80411, since the refractive power of the transmissive reflective lens is large, it becomes difficult to correct aberrations in an attempt to increase the aperture diameter. On the other hand, each example according to the present disclosure can provide an optical system that has high optical performance despite a large aperture diameter.

This application claims the benefit of Japanese Patent Application No. 2024-137050, which was filed on Aug. 16, 2024, and which is hereby incorporated by reference herein in its entirety.

What is claimed is:

1. An optical system comprising:
a first meniscus lens and a second meniscus lens spaced from each other and arranged in this order from an object side to an image side,
wherein the first meniscus lens includes a first transmissive reflective surface that is convex toward the object side,
wherein the second meniscus lens includes a second transmissive reflective surface that is convex toward the object side, and
wherein light from the object side transmits through the first transmissive reflective surface, is reflected toward the object side by the second transmissive reflective surface, is reflected toward the image side by the first transmissive reflective surface, and transmits through the second transmissive reflective surface toward the image side.

2. The optical system according to claim 1, wherein the following inequality is satisfied:
$$0. < \vert f / f 1 \vert \leq 0. 47$$
where f1 is a focal length of the first meniscus lens, and f is a focal length of the optical system.

3. The optical system according to claim 1, wherein the following inequality is satisfied:
$$0. < \vert f / f 2 \vert \leq 0. 56$$
where f2 is a focal length of the second meniscus lens, and f is a focal length of the optical system.

4. The optical system according to claim 1, wherein the following inequality is satisfied:
$$1.11 \leq \vert R 1 / f \vert \leq 3.47$$
where R1 is a radius of curvature of the first transmissive reflective surface, and f is a focal length of the optical system.

5. The optical system according to claim 1, wherein the following inequality is satisfied:
$$0. \leq \vert R 2 / f \vert \leq 3.46$$
where R2 is a radius of curvature of the second transmissive reflective surface, and f is a focal length of the optical system.

6. The optical system according to claim 1, wherein the following inequality is satisfied:
$$0. 29 \leq L 1 / f \leq 1.13$$
where L1 is a distance on an optical axis between the first meniscus lens and the second meniscus lens, and f is a focal length of the optical system.

7. The optical system according to claim 1, wherein no lens is provided between the first meniscus lens and the second meniscus lens.

8. The optical system according to claim 1, wherein the first meniscus lens includes the first transmissive reflective surface on the image side, and the second meniscus lens includes the second transmissive reflective surface on the image side.

9. An image pickup apparatus comprising:
the optical system according to claim 1; and
an image sensor configured to image the object via the optical system.

10. A system comprising:
the image pickup apparatus according to claim 9; and
a determining unit configured to determine a likelihood of collision between a moving apparatus and the object based on distance information on the object acquired by the image pickup apparatus.

11. The system according to claim 10, further comprising a control apparatus configured to output a control signal to a drive unit of the moving apparatus to generate a braking force in a case where it is determined that a collision is likely between the moving apparatus and the object.

12. The system according to claim 10, further comprising an alert apparatus configured to alert a user of the moving apparatus in a case where it is determined that a collision is likely between the moving apparatus and the object.

13. The system according to claim 10, further comprising a notification apparatus configured to notify outside of information on a collision between the moving apparatus and the object.

14. A moving apparatus comprising:
the image pickup apparatus according to claim 9,
wherein the image pickup apparatus is movable and held by the moving apparatus.

15. The moving apparatus according to claim 14, further comprising a determining unit configured to determine a likelihood of collision with the object based on distance information on the object acquired by the image pickup apparatus.

16. The moving apparatus according to claim 15, further comprising a control unit configured to output a control signal to control movement of the moving apparatus in a case where it is determined that there is a likelihood of collision with the object.

17. The moving apparatus according to claim 15, further comprising a warning unit configured to issue a warning to a user of the moving apparatus in a case where it is determined that a collision is likely between the moving apparatus and the object.

18. The moving apparatus according to claim 14, wherein a notification unit configured to notify outside of information on a collision with the object.
